(19) United States
(12) Patent Application Publication
(10) Pub. No.: US 2026/0323625 A1
(43) Pub. Date: Oct. 15, 2026

(54) METHOD AND APPARATUS FOR DEALING WITH DISTRIBUTION SYSTEM MAPPING CHANGE IN MULTI-ACCESS-POINT SYSTEM

(71) Applicant: MEDIATEK INC., Hsin-Chu (TW)

(72) Inventors: Chien-Fang Hsu, Hsinchu City (TW); Chih-Chun Kuo, Hsinchu City (TW); Hao-Hua Kang, Hsinchu City (TW)

(73) Assignee: MEDIATEK INC., Hsin-Chu (TW)

(21) Appl. No.: 19/473,802

(22) PCT Filed: Apr. 11, 2024
(86) PCT No.: PCT/CN2024/087271

§ 371 Date: Oct. 8, 2025

Related U.S. Application Data
(60) Provisional application No. 63/495,800, filed on Apr. 13, 2023.
(60) Provisional application No. 63/501,156, filed on May 10, 2023.
(60) Provisional application No. 63/627,051, filed on Jan. 30, 2024.

(51) Int. Cl. H04W 72/1263; H04W 36/08

(52) U.S. Cl. CPC H04W 72/1263; H04W 36/08

(57) ABSTRACT

A distribution system (DS) mapping change method includes: after a non-access-point station (non-AP STA) initiates transition from a first access point (AP) in a multi-AP (MAP) system to a second AP in the MAP system, initiating a DS mapping change procedure to instruct DS mapping change, wherein the DS mapping change is not handled by reassociation, and initiating DS mapping change procedure to instruct the DS mapping change includes: in response to the DS mapping change, transmitting a frame that carries information of the DS mapping change.

### BACKGROUND OF THE INVENTION

### 1. Field of the Invention

The present invention relates to wireless communications, and more particularly, to a method and apparatus for dealing with distribution system (DS) mapping change in a multi-access-point (MAP) system.

### 2. Description of the Prior Art

The DS provides means of connecting multiple access points (APs) together. For example, a first AP and a second AP are connected to the DS, and a first non-AP station (STA) associated with the first AP can communicate with a second non-AP STA associated with the second AP through the first AP, the DS, and the second AP. Before the DS sends data to a destination non-AP STA, it needs to know which AP is used by the destination non-AP STA to access the DS. When a non-AP STA travels from a first position within a service area of the first AP to a second position within a service area of the second AP, the reassociation service can be invoked to move a current association of the non-AP STA from the first AP to the second AP. In addition, DS mapping change is handled by reassociation to inform the DS of the mapping between the non-AP STA and the second AP.

With development of the Wi-Fi technology, an MAP system is proposed. In the MAP system, there are multiple APs (e.g., AP multilink devices (MLDs)) coordinated to serve non-AP stations (STAs) (e.g., non-AP MLDs). When a non-AP STA (e.g., non-AP MLD) travels from a first position within a service area of a first AP (e.g., AP MLD) in the MAP system to a second position within a service area of a second AP (e.g., AP MLD) in the same MAP system, moving a current association of the non-AP STA from the first AP to the second AP is not reassociation while the two APs are within the same MAP system. Instead of reassociation, the MAP system should provide an alternative way to enable DS mapping change. In addition, there is a need for a protocol design that determines the DS mapping change during a roaming or transition period of a client of the MAP system.

### SUMMARY OF THE INVENTION

One of the objectives of the claimed invention is to provide a method and apparatus for dealing with DS mapping change in an MAP system.

According to a first aspect of the present invention, an exemplary DS mapping change method is disclosed. The DS mapping change method includes: after a non-AP STA initiates transition from a first AP in an MAP system to a second AP in the MAP system, initiating a DS mapping change procedure to instruct DS mapping change, wherein the DS mapping change is not handled by reassociation, and initiating the DS mapping change procedure to instruct the DS mapping change includes: in response to the DS mapping change, transmitting a frame that carries information of the DS mapping change.

According to a second aspect of the present invention, an exemplary wireless communication device is disclosed. The exemplary wireless communication device includes a network interface circuit and a control circuit. The control circuit is arranged to generate a frame that carries information of DS mapping change after a non-AP STA initiates transition from a first AP in an MAP system to a second AP in the MAP system, and instruct the network interface circuit to transmit the frame to another wireless communication device. The DS mapping change is not handled by reassociation. One of the wireless communication device and the another wireless communication device belongs to the MAP system, and another of the wireless communication device and the another wireless communication device is the non-AP STA.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a configuration of a wireless communication system before transition (roaming) is initiated.

FIG. 2 is a diagram illustrating a configuration of a wireless communication system after DS mapping change is completed.

FIG. 3 is a diagram illustrating a wireless communication system that employs a first DS mapping change method according to an embodiment of the present invention.

FIG. 4 is a diagram illustrating a wireless communication system that employs a second DS mapping change method according to an embodiment of the present invention.

FIG. 5 is a diagram illustrating a wireless communication system that employs a third DS mapping change method according to an embodiment of the present invention.

FIG. 6 is a diagram illustrating another wireless communication system that employs the third DS mapping change method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

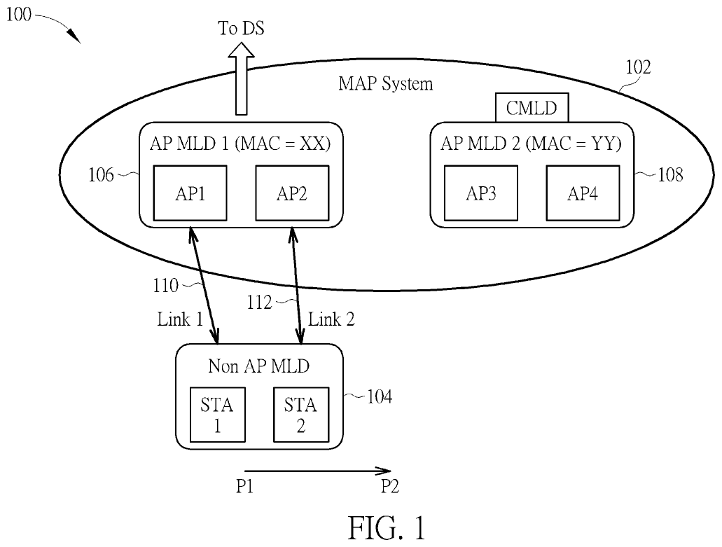

FIG. 1 is a diagram illustrating a configuration of a wireless communication system before transition (roaming) is initiated. The wireless communication system 100 may be a Wi-Fi system compliant with IEEE 802.11bn (Wi-Fi 8) standard or a next-generation Wi-Fi standard. The wireless communication system 100 includes an MAP system 102 that includes multiple APs. For brevity and simplicity, only two APs 106 and 108 are shown in FIG. 1. In addition, a non-AP STA 104 is associated with AP 106 of MAP system 102. It should be noted that an AP of the MAP system 102 may be an AP MLD which owns multiple links working on different RF bands and capable of operating at the same time, or may be a non-MLD AP. Hence, the MAP system 102 that supports the proposed DS mapping change scheme may be formed by multiple AP MLDs, multiple non-MLD APs, or a combination thereof. In this embodiment, the APs 106 and 108 are implemented by AP MLDs with different media access control (MAC) addresses (labeled by “AP MLD 1 (MAC=XX)” and “AP MLD 2 (MAC=YY)”), respectively. For example, one AP MLD may have two affiliated APs (labeled by “AP1” and “AP2”), and another AP MLD may have two affiliated APs (labeled by “AP3” and “AP4”). In addition, a common-MLD (CMLD) is embedded in one AP MLD to coordinate MAP operations between MLDs, including authentication, key distribution/update, etc. Multiple AP MLDs may be non-collocated and connected via a backhaul, and the CMLD coordinates them as a MAP system. In this embodiment, the non-AP STA 104 is implemented by a non-AP MLD that includes two affiliated STAs (labeled by “STA 1” and “STA 2”). Hence, the non-AP STA (e.g., non-AP MLD) 104 is connected to the AP (e.g., AP MLD) 106 through multiple links (labeled by “Link 1” and “Link 2”) 110 and 112. When the non-AP STA 104 moves from a current location P1 to a different location P2, the non-AP STA 104 may request transition from the AP 106 to the AP 108. Since both of the APs 106 and 108 are within the same MAP system 102, the proposed DS mapping change scheme can be used to deal with DS mapping change without reassociation.

Before the DS mapping change is completed, the DS is informed of the mapping between the non-AP STA 104 and the AP 106, and the non-AP STA 104 communicates with the DS through the AP 106. After the DS mapping change is completed, the DS is informed of the mapping between the non-AP STA 104 and the AP 108, and the non-AP STA 104 communicates with the DS through the AP 108. In accordance with the proposed DS mapping change scheme, the DS mapping change is not handled by reassociation.

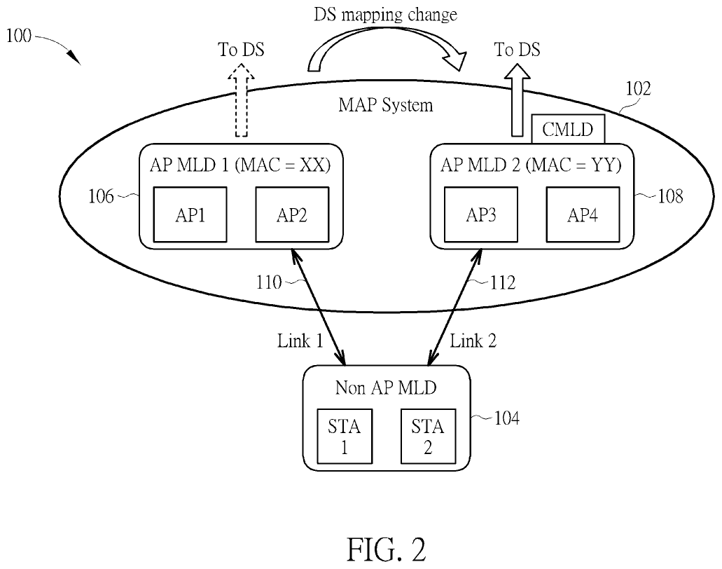

When the non-AP STA (non-AP MLD) 104 moves from a current location P1 to a different location P2, the non-AP STA (non-AP MLD) 104 initiates transition (i.e., roaming) from one AP (AP MLD) 106 to another AP (AP MLD) 108 by link addition (or link switch) that establishes a link (labeled by “Link 2”) 112 between the non-AP STA (non-AP MLD) 104 and the AP (AP MLD) 108. In this embodiment, the non-AP STA (non-AP MLD) 104 initiates transition (i.e., roaming) by establishing at least one second link between the non-AP STA (non-AP MLD) 104 and the AP (AP MLD) 108 while maintaining at least one first link between non-AP STA (non-AP MLD) 104 and the AP (AP MLD) 106. As shown in FIG. 2, two links 110 and 112 are connected to different APs 106 and 108, respectively.

Any stage between an initial stage of roaming and a final stage of roaming may be regarded as a part of a transition stage. For example, a stage of having multiple links of a non-AP STA (non-AP MLD) connected to an original serving AP (AP MLD) and a new serving AP (AP MLD) before the non-AP STA (non-AP MLD) is disconnected from the original serving AP (AP MLD) may be regarded as a part of the transition stage. As shown in FIG. 2, the non-AP STA (non-AP MLD) 104 stays in the transition stage at the time the DS mapping change is completed. After the DS mapping change is completed, the non-AP STA (non-AP MLD) 104 deletes/disconnects link(s) of the AP (AP MLD 1) 106 to complete the roaming.

The transition may trigger the DS mapping change. Hence, when the transition is initiated by a client of the MAP system, actions should be taken to decide if DS mapping needs to change. In accordance with the proposed DS mapping change scheme, after the non-AP STA (non-AP MLD) 104 initiates transition from one AP (AP MLD 1) 106 in the MAP system 102 to another AP (AP MLD 2) 108 in the same MAP system 102, a DS mapping change procedure (which may include DS mapping change decision making) is initiated to instruct DS mapping change, where the DS mapping change is not handled by reassociation due to the fact that both APs 106 and 108 are within the same MAP system 102. For example, in response to the DS mapping change instructed by the DS mapping change procedure (e.g., DS mapping change decision made by the DS mapping change procedure), a frame that carries information of the DS mapping change is transmitted between the network (i.e., MAP system 102) and the client (i.e., non-AP STA (non-AP MLD) 104). Further details of determining the DS mapping change are described as below with reference to the accompanying drawings.

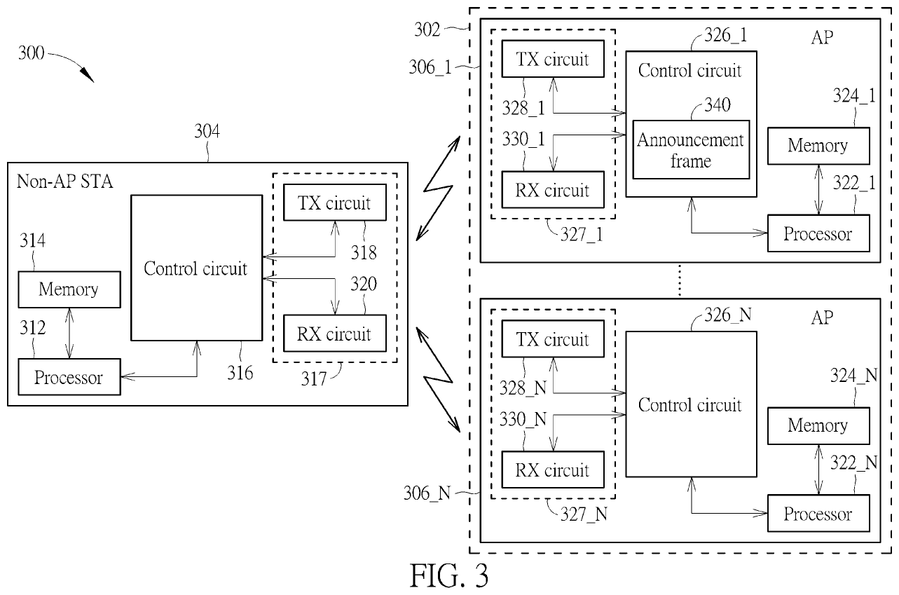

FIG. 3 is a diagram illustrating a wireless communication system that employs a first DS mapping change method according to an embodiment of the present invention. The wireless communication system 300 may be a Wi-Fi system compliant with IEEE 802.11bn (Wi-Fi 8) standard or a next-generation Wi-Fi standard. The wireless communication system 300 includes an MAP system 302 and a non-AP STA 304. The MAP system 302 includes a plurality of APs 306_1-306_N (N≥2). In this embodiment, the non-AP STA 304 may be a non-AP MLD. It should be noted that an AP of the MAP system 302 may be an AP MLD or a non-MLD AP. Hence, the MAP system 302 that supports the proposed DS mapping change scheme may be formed by multiple AP MLDs, multiple non-MLD APs, or a combination thereof. The wireless communication system 100 shown in FIGS. 1-2 may be implemented using the wireless communication system 300, where the non-AP STA 304 may act as the non-AP STA (non-AP MLD) 104, the AP 306_1 may act as the AP (AP MLD) 106, and the AP 306_N may act as the AP (AP MLD) 108.

For brevity and simplicity, it is assumed that the wireless communication devices in the wireless communication system 300 may have the same or similar circuit structure. As shown in FIG. 3, the non-AP STA 304 includes a processor 312, a memory 314, a control circuit 316, and a network interface circuit 317, where the network interface circuit 317 includes a transmitter (TX) circuit 318 and a receiver (RX) circuit 320. When the non-AP STA 304 is a non-AP MLD, the TX circuit 318 may have multiple transmitters, and the RX circuit 320 may have multiple receivers. The AP 306_1/306_N includes a processor 322_1/322_N, a memory 324_1/324_N, a control circuit 326_1/326_N, and a network interface circuit 327_1/327_N, where the network interface circuit 327_1/327_N includes a TX circuit 328_1/328_N and an RX circuit 330_1/330_N. When the AP 306_1/306_N is an AP MLD, the TX circuit 328_1/328_N may include multiple transmitters, and the RX circuit 330_1/330_N may include multiple receivers.

The memory 314/324_1/324_N is arranged to store a program code. The processor 312/322_1/322_N is arranged to load and execute the program code to manage the wireless communication device. The control circuit 316/326_1/326_N is arranged to control communications with non-AP STAs and/or APs. For example, the control circuit 316/326_1/326_N controls the TX circuit 318/328_1/328_N of the network interface circuit 317/327_1/327_N to send frames to non-AP STAs and/or APs, and controls the RX circuit 320/322_1/322_N of the network interface circuit 317/327_1/327_N to receive frames from non-AP STAs and/or APs.

It should be noted that only the components pertinent to the present invention are illustrated in FIG. 3. In practice, the non-AP STA 304 may include additional components to achieve designated functions, and each of APs 306_1-306_N may include additional components to achieve designated functions. Since the present invention is focused on the proposed DS mapping change scheme, further description of software control and hardware circuits of non-AP STA 304 and APs 306_1-306_N is omitted here for brevity.

A first DS mapping change method is employed by the wireless communication system 100 shown in FIG. 3. Specifically, the DS mapping change procedure (which may include DS mapping change decision making) is initiated by APs (AP MLDs) 306_1-306_N (which are coordinated as MAP system 302) only. The MAP system 302 may consider multiple factors to make the DS mapping change decision. For example, the MAP system 302 is aware of the traffic condition and the backhaul bandwidth, and can make the DS mapping change decision (which decides timing of DS mapping change) to minimize the data forwarding traffic between two APs (AP MLDs) to relax the backhaul bandwidth requirements in the transition stage (which is a stage of having multiple links of a non-AP STA (non-AP MLD) connected to an original serving AP (AP MLD) and a new serving AP (AP MLD) before the non-AP STA (non-AP MLD) is disconnected from the original serving AP (AP MLD)). Since the DS mapping change decision is made by the MAP system 302 only, the client (i.e., non-AP STA 304) has no need to implement any decision-making mechanisms. Hence, the first DS mapping change method has no complexity impact on the client of the MAP system 302.

In accordance with the first DS mapping change method, the MAP system 302 needs to transmit an announcement frame (which carries information of the DS mapping change) in response to the DS mapping change decision made by MAP system 302. The announcement frame can be transmitted through any link available between the MAP system 302 and the non-AP STA 304. For example, assuming that the AP 306_1 (e.g., AP 106 shown in FIG. 2) remains connected to the non-AP STA 304 (e.g., non-AP STA 104 shown in FIG. 2) after transition is initiated by the non-AP STA 304, the control circuit 326_1 of the AP 306_1 generates an announcement frame 340, and instructs the network interface circuit 327_1 (particularly, TX circuit 328_1 of network interface circuit 327_1) to transmit the announcement frame 340 to the non-AP STA 304. The announcement frame 340 carries information of the DS mapping change. For example, the announcement frame 340 may include target DS mapping indication (e.g., new DS mapping that is associated with AP 306_N). In some embodiments of the present invention, the announcement frame 340 may indicate completion of the DS mapping change. That is, the announcement frame 340 may be indicative of that the DS mapping change has been applied.

The announcement frame 340 may further indicate timing of the DS mapping change. In some embodiments of the present invention, the announcement frame 340 may indicate that the DS mapping change is applied immediately after transmission of the announcement frame 340. In some embodiments of the present invention, the announcement frame 340 may indicate a time instant the DS mapping change is to be applies. In some embodiments of the present invention, the announcement frame 340 may indicate a timing offset between a time instant the announcement frame 340 is transmitted and a time instant the DS mapping change is to be applied.

Consider a case where the non-AP STA (non-AP MLD) 104 shown in FIGS. 1-2 is implemented by the non-AP STA 304 shown in FIG. 3, the AP (AP MLD) 106 shown in FIGS. 1-2 is implemented by the AP 306_1 shown in FIG. 3, and the AP (AP MLD) 108 shown in FIGS. 1-2 is implemented by the AP 306_N shown in FIG. 3. As shown in FIG. 2, the non-AP STA (non-AP MLD) 104 has two links 110 and 112 connected to different APs (AP MLDs) 106 and 108 after the DS mapping change procedure is completed. After the DS mapping change procedure is completed, the non-AP STA (non-AP MLD) 104 deletes/disconnects link(s) of the AP (AP MLD) 106 to complete the roaming. Hence, before the non-AP STA (non-AP MLD) 104 is disconnected from the AP (AP MLD) 106, the link 110 remains connected between the non-AP STA (non-AP MLD) 104 and the AP (AP MLD) 106, and can be used for data transfer.

When data forwarding from the AP (AP MLD) 106 to the AP (AP MLD) 108 is available after the DS mapping change procedure is completed and before the non-AP STA (non-AP MLD) 104 is disconnected from the AP (AP MLD) 106, uplink (UL) data buffered in the non-AP STA (non-AP MLD) 104 can be transmitted to the AP (AP MLD) 106 via the link 110 and then forwarded to the AP (AP MLD) 108. For certain low-latency applications, the non-AP STA (non-AP MLD) 104 may need to arrange the UL traffic to minimize the latency resulting from data forwarding overhead between the APs (AP MLDs) 106 and 108. For example, during a period in which the non-AP STA (non-AP MLD) 104 has links connected to the APs (AP MLDs) 106 and 108 and data forwarding from the AP (AP MLD) 106 to the AP (AP MLD) 108 is available after the DS mapping change is completed, the non-AP STA (non-AP MLD) 104 may limit (i.e., partially allow) or disallow UL traffic through the link 110 between the non-AP STA (non-AP MLD) 104 and the AP (AP MLD) 106.

When data forwarding from the AP (AP MLD) 106 to the AP (AP MLD) 108 is unavailable after the non-AP STA (non-AP MLD) 104 initiates the transition (or after the non-AP STA (non-AP MLD) 104 receives an announcement frame (e.g., announcement frame 340) from the MAP system 102), the non-AP STA (non-AP MLD) 104 may restrict UL traffic through the link 110 between the non-AP STA (non-AP MLD) 104 and the AP (AP MLD) 106 to protect the ongoing DS mapping change procedure from being disrupted by the UL traffic on the link 110. For example, during a period in which the non-AP STA (non-AP MLD) 104 has links connected to the APs (AP MLDs) 106 and 108 and data forwarding from the AP (AP MLD) 106 to the AP (AP MLD) 108 is unavailable after the non-AP STA (non-AP MLD) 104 initiates the transition (or after the non-AP STA (non-AP MLD) 104 receives the announcement frame), the non-AP STA (non-AP MLD) 104 may disallow UL traffic through the link 110 between the non-AP STA 104 and the AP (AP MLD) 106. In addition, before the DS mapping change is completed, the non-AP STA (non-AP MLD) 104 may need to buffer UL data.

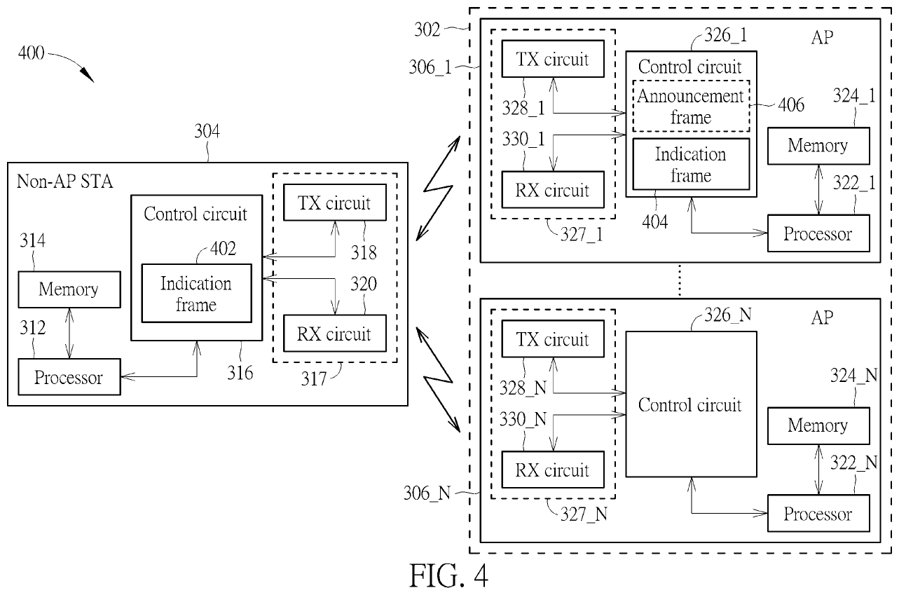

FIG. 4 is a diagram illustrating a wireless communication system that employs a second DS mapping change method according to an embodiment of the present invention. The second DS mapping change method is employed by the wireless communication system 400 shown in FIG. 4. Specifically, the DS mapping change procedure (which may include DS mapping change decision making) is initiated by the non-AP STA 304 only. Compared to the APs 306_1-306_N (MAP system 302), the client (i.e., non-AP STA 304) has better knowledge of it UL traffic flow. The timing to transmit an indication frame to instruct the DS mapping change can also be critical. For example, the non-AP STA 304 (e.g., non-AP STA 104 shown in FIG. 1) may have queued UL data to be transmitted over a link between the non-AP STA 304 and the AP 306_1 (e.g., AP 106 shown in FIG. 1), and it is better to instruct the DS mapping change after transmission of the queued UL data is completed. Compared to the first DS mapping change method, the second DS mapping change method requires decision-making mechanisms implemented on the client (i.e., non-AP STA 304).

In accordance with the second DS mapping change method, the non-AP STA 304 needs to transmit an indication frame 402 (which carries information of the DS mapping change) in response to the DS mapping change decision made by non-AP STA 304. The indication frame (or request frame) 402 can be transmitted through any link available between the MAP system 302 and the non-AP STA 304. For example, assuming that the AP 306_1 (e.g., AP 106 shown in FIG. 2) remains connected to the non-AP STA 304 (e.g., non-AP STA 104 shown in FIG. 2) after transition is initiated by the non-AP STA 304, the control circuit 316 of the non-AP STA 304 generates the indication frame 402, and instructs the network interface circuit 317 (particularly, TX circuit 318 of network interface circuit 317) to transmit the indication frame 402 to the AP 306_1. The indication frame 402 carries information of the DS mapping change. For example, the indication frame 402 may include target DS mapping indication (e.g., new DS mapping that is associated with AP 306_N).

After the indication frame 402 sent from the non-AP STA 304 to instruct DS mapping change is received by the MAP system 302, the MAP system 302 sends back another indication frame 404 to the non-AP STA 304. The indication frame 404 can be transmitted through any link available between the MAP system 302 and the non-AP STA 304. For example, the control circuit 326_1 of the AP 306_1 generates the indication frame 404, and instructs the network interface circuit 327_1 (particularly, TX circuit 328_1 of network interface circuit 327_1) to transmit the indication frame 404 to the non-AP STA 304. The indication frame 404 may indicate timing of the DS mapping change. In some embodiments of the present invention, the indication frame 404 may indicate that the DS mapping change is applied immediately after transmission of the indication frame 404. In some embodiments of the present invention, the indication frame 404 may indicate a time instant the DS mapping change is to be applies. In some embodiments of the present invention, the indication frame 404 may indicate a timing offset between a time instant the indication frame 404 is transmitted and a time instant the DS mapping change is to be applied.

In a case where the DS mapping change is not applied immediately after transmission of the indication frame 404, the network (i.e., MAP system 302) may send an announcement frame with a DS mapping change status to inform the client (i.e., non-AP STA 304) of completion of the DS mapping change. The announcement frame can be transmitted through any link available between the MAP system 302 and the non-AP STA 304. For example, after the DS mapping change is completed and before the non-AP STA 304 is disconnected from the AP 306_1, the control circuit 326_1 of the AP 306_1 further generates an announcement frame 406, and instructs the network interface circuit 327_1 (particularly, TX circuit 328_1 of network interface circuit 327_1) to transmit the announcement frame 406 to the non-AP STA 304.

Consider a case where the non-AP STA (non-AP MLD) 104 shown in FIGS. 1-2 is implemented by the non-AP STA 304 shown in FIG. 4, the AP (AP MLD) 106 shown in FIGS. 1-2 is implemented by the AP 306_1 shown in FIG. 4, and the AP (AP MLD) 108 shown in FIGS. 1-2 is implemented by the AP 306_N shown in FIG. 4. As shown in FIG. 2, the non-AP STA (non-AP MLD) 104 has two links 110 and 112 connected to different APs (AP MLDs) 106 and 108 after the DS mapping change procedure is completed. After the DS mapping change procedure is completed, the non-AP STA (non-AP MLD) 104 deletes/disconnects link(s) of the AP (AP MLD) 106 to complete the roaming. Hence, before the non-AP STA (non-AP MLD) 104 is disconnected from the AP (AP MLD) 106, the link 110 remains connected between the non-AP STA (non-AP MLD) 104 and the AP (AP MLD) 106, and can be used for data transfer.

When data forwarding from the AP (AP MLD) 106 to the AP (AP MLD) 108 is available after the DS mapping change procedure is completed and before the non-AP STA (non-AP MLD) 104 is disconnected from the AP (AP MLD) 106, UL data buffered in the non-AP STA (non-AP MLD) 104 can be transmitted to the AP (AP MLD) 106 via the link 110 and then forwarded to the AP (AP MLD) 108. For certain low-latency applications, the non-AP STA (non-AP MLD) 104 may need to arrange the UL traffic to minimize the latency resulting from data forwarding overhead between the APs (AP MLDs) 106 and 108. For example, during a period in which the non-AP STA (non-AP MLD) 104 has links connected to the APs (AP MLDs) 106 and 108 and data forwarding from the AP (AP MLD) 106 to the AP (AP MLD) 108 is available after the DS mapping change is completed, the non-AP STA 104 may limit (i.e., partially allow) or disallow UL traffic through the link 110 between the non-AP STA (non-AP MLD) 104 and the AP (AP MLD) 106.

When data forwarding from the AP (AP MLD) 106 to the AP (AP MLD) 108 is unavailable after the non-AP STA (non-AP MLD) 104 initiates the transition (or after the non-AP STA (non-AP MLD) 104 transmits an indication frame (e.g., indication frame 402) to the MAP system 102), the non-AP STA 104 may restrict UL traffic through the link 110 between the non-AP STA (non-AP MLD) 104 and the AP (AP MLD) 106 to protect the ongoing DS mapping change procedure from being disrupted by the UL traffic on the link 110. For example, during a period in which the non-AP STA (non-AP MLD) 104 has links connected to the APs (AP MLDs) 106 and 108 and data forwarding from the AP (AP MLD) 106 to the AP (AP MLD) 108 is unavailable after the non-AP STA (non-AP MLD) 104 initiates the transition (or after the non-AP STA (non-AP MLD) 104 transmits the indication frame), the non-AP STA (non-AP MLD) 104 may disallow UL traffic through the link 110 between the non-AP STA (non-AP MLD) 104 and the AP (AP MLD) 106. In addition, before the DS mapping change is completed, the non-AP STA (non-AP MLD) 104 may need to buffer UL data.

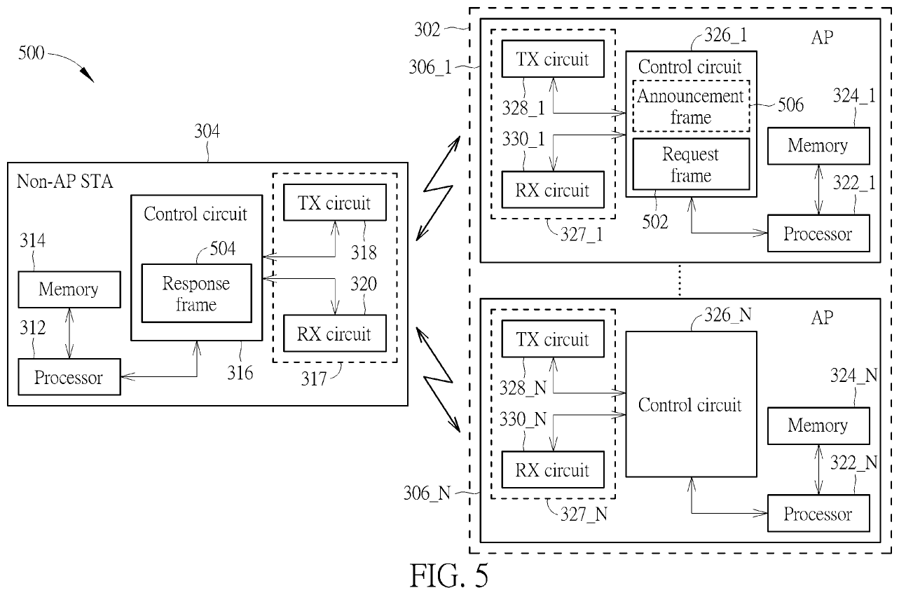

FIG. 5 is a diagram illustrating a wireless communication system that employs a third DS mapping change method according to an embodiment of the present invention. The third DS mapping change method is employed by the wireless communication system 500 shown in FIG. 5. Specifically, the DS mapping change procedure (which may include DS mapping change decision making) is initiated by negotiation between the non-AP STA 304 and the MAP system 302. The DS mapping change decision made by two parties (MAP system 302 and the non-AP STA 304) may bring balanced traffic management of the backhaul, the UL and the DL. Compared to the first DS mapping change method and the second DS mapping change method, the third DS mapping change method requires decision-making mechanisms implemented on both of the client (i.e., non-AP STA 304) and the network (i.e., MAP system 302).

In accordance with the third DS mapping change method, the negotiation may be initiated by any of the client (i.e., non-AP STA 304) and the network (i.e., MAP system 302). Regarding the embodiment shown in FIG. 5, the negotiation is initiated by the network (i.e., MAP system 302). Hence, the MAP system 302 needs to transmit a request frame (which carries information of the DS mapping change) to the non-AP STA 304. The request frame can be transmitted through any link available between the MAP system 302 and the non-AP STA 304. For example, assuming that the AP 306_1 (e.g., AP 106 shown in FIG. 2) remains connected to the non-AP STA 304 (e.g., non-AP STA 104 shown in FIG. 2) after transition is initiated by the non-AP STA 304, the control circuit 326_1 of the AP 306_1 generates a request frame 502, and instructs the network interface circuit 327_1 (particularly, TX circuit 328_1 of network interface circuit 327_1) to transmit the request frame 502 to the non-AP STA 304. The request frame 502 carries information of the DS mapping change. For example, the request frame 502 may include target DS mapping indication (e.g., new DS mapping that is associated with AP 306_N).

The request frame 502 may further indicate timing of the DS mapping change. In some embodiments of the present invention, the request frame 502 may indicate that the DS mapping change is applied immediately after transmission of the request frame 502. In some embodiments of the present invention, the request frame 502 may indicate a time instant the DS mapping change is to be applies. In some embodiments of the present invention, the request frame 502 may indicate a timing offset between a time instant the request frame 502 is transmitted and a time instant the DS mapping change is to be applied.

After the request frame 502 sent from the MAP system 302 to instruct DS mapping change is received by the non-AP STA 304, the non-AP STA 304 sends a response frame to respond the request frame 502 with confirmation of the DS mapping change suggested by MAP system 302 or rejection of the DS mapping change suggested by MAP system 302, where the rejection may be accompanied by a counter indication of DS mapping which is different from that suggested by MAP system 302. The response frame can be transmitted through any link available between the MAP system 302 and the non-AP STA 304. For example, the control circuit 316 of the non-AP STA 304 generates the response frame 504, and instructs the network interface circuit 317 (particularly, TX circuit 318 of network interface circuit 317) to transmit the response frame 504 to the AP 306_1.

In a case where the DS mapping change is not applied immediately after transmission of the request frame 502, the network (i.e., MAP system 302) may send an announcement frame with a DS mapping change status to inform the client (i.e., non-AP STA 304) of completion of the DS mapping change that is confirmed through the negotiation process. The announcement frame can be transmitted through any link available between the MAP system 302 and the non-AP STA 304. For example, after the DS mapping change is completed, the control circuit 326_1 of the AP 306_1 further generates an announcement frame 506, and instructs the network interface circuit 327_1 (particularly, TX circuit 328_1 of network interface circuit 327_1) to transmit the announcement frame 506 to the non-AP STA 304.

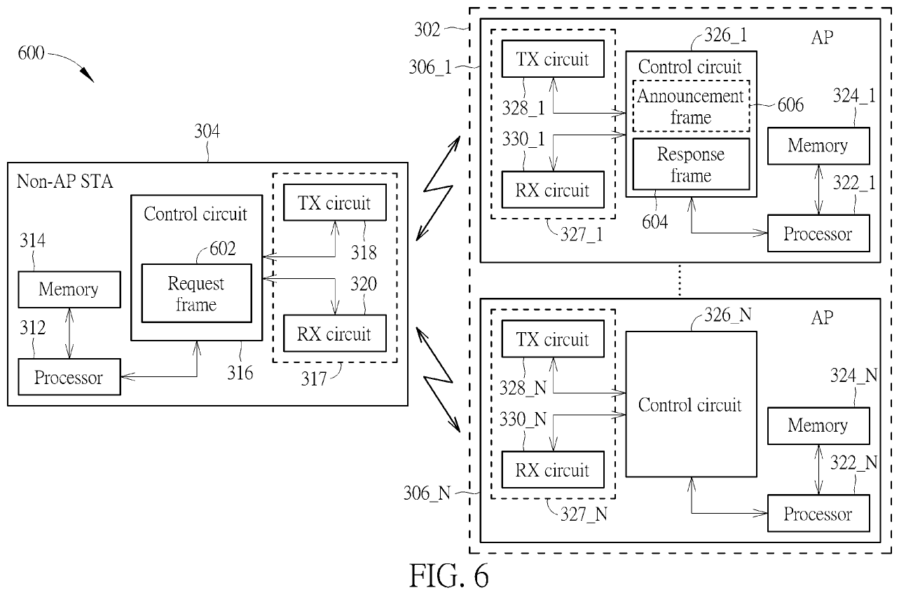

FIG. 6 is a diagram illustrating another wireless communication system that employs the third DS mapping change method according to an embodiment of the present invention. The third DS mapping change method is employed by the wireless communication system 600 shown in FIG. 6. The major difference between the wireless communication systems 500 and 600 is that the negotiation is initiated by the client (i.e., non-AP STA 304) in the wireless communication system 600. The non-AP STA 304 needs to transmit a request frame 602 (which carries information of the DS mapping change) to the MAP system 302. The request frame 602 can be transmitted through any link available between the MAP system 302 and the non-AP STA 304. For example, assuming that the AP 306_1 (e.g., AP 106 shown in FIG. 2) remains connected to the non-AP STA 304 (e.g., non-AP STA 104) after transition is initiated by the non-AP STA 304, the control circuit 316 of the non-AP STA 304 generates the request frame 602, and instructs the network interface circuit 317 (particularly, TX circuit 318 of network interface circuit 317) to transmit the request frame 602 to the AP 306_1. The request frame 602 carries information of the DS mapping change. For example, the request frame 602 may include target DS mapping indication (e.g., new DS mapping that is associated with AP 306_N).

After the request frame 602 sent from the non-AP STA 304 to instruct DS mapping change is received by the MAP system 302, the MAP system 302 sends a response frame to respond the request frame 602 with confirmation of the DS mapping change suggested by non-AP STA 304 or rejection of the DS mapping change suggested by non-AP STA 304. The response frame can be transmitted through any link available between the MAP system 302 and the non-AP STA 304. For example, the control circuit 326_1 of the AP 306_1 further generates a response frame 604, and instructs the network interface circuit 327_1 (particularly, TX circuit 328_1 of network interface circuit 327_1) to transmit the response frame 604 to the non-AP STA 304.

The rejection indicated by the response frame 604 may be accompanied by a counter indication of DS mapping which is different that suggested by non-AP STA 304. The confirmation indicated by the response frame 604 may further indicate timing of the DS mapping change. In some embodiments of the present invention, the response frame 604 may indicate that the DS mapping change is applied immediately after transmission of the response frame 604. In some embodiments of the present invention, the response frame 604 may indicate a time instant the DS mapping change is to be applies. In some embodiments of the present invention, the response frame 604 may indicate a timing offset between a time instant the response frame 604 is transmitted and a time instant the DS mapping change is to be applied.

In a case where the DS mapping change is not applied immediately after transmission of the response frame 604, the network (i.e., MAP system 302) may send an announcement frame with a DS mapping change status to inform the client (i.e., non-AP STA 304) of completion of the DS mapping change that is confirmed through the negotiation process. The announcement frame can be transmitted through any link available between the MAP system 302 and the non-AP STA 304. For example, after the DS mapping change is completed and before the non-AP STA 304 is disconnected from the AP 306_1, the control circuit 326_1 of the AP 306_1 generates an announcement frame 606, and instructs the network interface circuit 327_1 (particularly, TX circuit 328_1 of network interface circuit 327_1) to transmit the announcement frame 606 to the non-AP STA 304.

Consider a case where the non-AP STA (non-AP MLD) 104 shown in FIGS. 1-2 is implemented by the non-AP STA 304 shown in FIG. 6, the AP (AP MLD) 106 shown in FIGS. 1-2 is implemented by the AP 306_1 shown in FIG. 6, and the AP (AP MLD) 108 shown in FIGS. 1-2 is implemented by the AP 306_N shown in FIG. 6. When data forwarding from the AP (AP MLD) 106 to the AP (AP MLD) 108 is unavailable after the non-AP STA (non-AP MLD) 104 initiates the negotiation, the non-AP STA (non-AP MLD) 104 may restrict UL traffic through the link 110 between the non-AP STA (non-AP MLD) 104 and the AP (AP MLD) 106 to protect the ongoing DS mapping change procedure from being disrupted by the UL traffic on the link 110. For example, during a period in which the non-AP STA (non-AP MLD) 104 has links connected to the APs (AP MLDs) 106 and 108 and data forwarding from the AP (AP MLD) 106 to the AP (AP MLD) 108 is unavailable after the non-AP STA (non-APMLD) 104 initiates the negotiation, the non-AP STA (non-AP MLD) 104 may disallow UL traffic through the link 110 between the non-AP STA (non-AP MLD) 104 and the AP (AP MLD) 106. In addition, before the DS mapping change is completed, the non-AP STA (non-AP MLD) 104 may need to buffer UL data.

As mentioned above, the announcement frame 340 (which is generated and sent by the MAP system that makes the DS mapping change decision), the indication frame 402 (which is generated and sent by the non-AP STA that makes the DS mapping change decision), the request frame 502 (which is generated and sent by the MAP system that initiates negotiation for determining the DS mapping change), and the request frame 602 (which is generated and sent by the non-AP STA that initiates negotiation for determining the DS mapping change) are used to carry information of the DS mapping change. For example, information of the DS mapping change may be set to indicate the DS mapping status or preference, and may include a MAC address of a target AP, a predefined identifier (ID) of the target AP, or information indicating that DS mapping is associated with the target AP, where the target AP may be an AP MLD or a non-MLD AP.

During the negotiation process, the request frame 502/602 and the response frame 504/604 may carry client's MAC address and/or association identifier (AID) to indicate the identity of the client. For the client being a non-AP MLD, the non-AP MLD's MAC address is carried in the request frame 502/602 and the response frame 504/604.

The DS mapping status (indication) container can be put in the frame body directly or put in an information element (IE). An example of the IE format is shown below.

| | | | | Target | | Applied |
|---|---|---|---|---|---|---|
| | | | | AP MLD | | Timing |
| | | | | MAC | | in TSF |
| | | | Element | Address | Client | (or timing |
| | Element | | ID | (or AP | MAC | offset of |
| | ID | Length | Extension | MLD ID) | Address | the change) |
| Octets: | 1 | 1 | 1 | 6 | 6 | 2 |

A timing synchronization function (TSF) value may be recorded in the information element to indicate a time instant the DS mapping change is to be applied, where the TSF value is determined based on a value of a local TSF timer implemented on an AP (or non-AP STA) that sends a frame containing the information element. Alternatively, a timing offset may be recorded in the information element to indicate an offset between a time instant the frame is transmitted (i.e., sending time of the frame) and a time instant the DS mapping change is to be applied. If the timing offset is set by a zero value, it indicates that the DS mapping change is applied immediately after the frame is transmitted.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A distribution system (DS) mapping change method comprising:
after a non-access-point station (non-AP STA) initiates transition from a first access point (AP) in a multi-AP (MAP) system to a second AP in the MAP system, initiating a DS mapping change procedure to instruct DS mapping change;
wherein the DS mapping change is not handled by reassociation, and initiating the DS mapping change procedure to instruct the DS mapping change comprises:
in response to the DS mapping change, transmitting a frame that carries information of the DS mapping change.

2. The DS mapping change method of claim 1, wherein the DS mapping change procedure is initiated by the MAP system, and the frame is an announcement frame that is transmitted from the MAP system to the non-AP STA.

3. The DS mapping change method of claim 2, wherein the announcement frame is indicative of that the DS mapping change has been applied or indicative of timing of the DS mapping change.

4. The DS mapping change method of claim 3, wherein the announcement frame is indicative of the timing of the DS mapping change, where:
the announcement frame indicates that the DS mapping change is applied immediately after transmission of the announcement frame; or
the announcement frame indicates a time instant the DS mapping change is to be applies; or
the announcement frame indicates a timing offset between a time instant the announcement frame is transmitted and a time instant the DS mapping change is to be applied.

5. The DS mapping change method of claim 2, further comprising:
during a period in which the non-AP STA has links connected to the first AP and the second AP and data forwarding from the first AP to the second AP is available after the DS mapping change is completed, limiting or disallowing uplink (UL) traffic through a link between the non-AP STA and the first AP.

6. The DS mapping change method of claim 2, further comprising:
during a period in which the non-AP STA has links connected to the first AP and the second AP and data forwarding from the first AP to the second AP is unavailable after the non-AP STA initiates the transition or receives the announcement frame, disallowing uplink (UL) traffic through a link between the non-AP STA and the first AP.

7. The DS mapping change method of claim 1, wherein the DS mapping change procedure is initiated by the non-AP STA, and the frame is an indication frame that is transmitted from the non-AP STA to the MAP system.

8. The DS mapping change method of claim 7, further comprising:
receiving another indication frame transmitted from the MAP system, wherein the another indication frame is indicative of timing of the DS mapping change.

9. The DS mapping change method of claim 8, wherein:
the another indication frame indicates that the DS mapping change is applied immediately after transmission of the another indication frame; or
the another indication frame indicates a time instant the DS mapping change is to be applies; or
the another indication frame indicates a timing offset between a time instant the another indication frame is transmitted and a time instant the DS mapping change is to be applied.

10. The DS mapping change method of claim 7, further comprising:
after the DS mapping change is completed, receiving an announcement frame with a DS mapping status that is transmitted from the MAP system.

11. The DS mapping change method of claim 7, further comprising:
during a period in which the non-AP STA has links connected to the first AP and the second AP and data forwarding from the first AP to the second AP is available after the DS mapping change is completed, limiting or disallowing uplink (UL) traffic through a link between the non-AP STA and the first AP.

12. The DS mapping change method of claim 7, further comprising:
during a period in which the non-AP STA has links connected to the first AP and the second AP and data forwarding from the first AP to the second AP is unavailable after the non-AP STA initiates the transition or transmits the indication frame, disallowing uplink (UL) traffic through a link between the non-AP STA and the first AP.

13. The DS mapping change method of claim 1, wherein the DS mapping change procedure is initiated by negotiation between the non-AP STA and the MAP system, the frame is a request frame transmitted from one of the non-AP STA and the MAP system.

14. The DS mapping change method of claim 13, wherein the negotiation is initiated by the non-AP STA.

15. The DS mapping change method of claim 13, wherein the negotiation is initiated by the MAP system.

16. The DS mapping change method of claim 13, wherein initiating the DS mapping change procedure to instruct the DS mapping change further comprises:
receiving a response frame transmitted from another of the non-AP STA and the MAP system.

17. The DS mapping change method of claim 16, wherein one of the request frame and the response frame is indicative of timing of the DS mapping change.

18. The DS mapping change method of claim 17, wherein:
the one of the request frame and the response frame indicates that the DS mapping change is applied immediately after transmission of the one of the request frame and the response frame; or
the one of the request frame and the response frame indicates a time instant the DS mapping change is to be applies; or
the one of the request frame and the response frame indicates a timing offset between a time instant the one of the request frame and the response frame is transmitted and a time instant the DS mapping change is to be applied.

19. The DS mapping change method of claim 13, wherein after the DS mapping change is completed, an announcement frame with a DS mapping status is transmitted by the MAP system.

20. A wireless communication device comprising:
a network interface circuit; and
a control circuit, arranged to generate a frame that carries information of DS mapping change after a non-access-point station (non-AP STA) initiates transition from a first access point (AP) in a multi-AP (MAP) system to a second AP in the MAP system, and instruct the network interface circuit to transmit the frame to another wireless communication device;
wherein the DS mapping change is not handled by reassociation, one of the wireless communication device and the another wireless communication device belongs to the MAP system, and another of the wireless communication device and the another wireless communication device is the non-AP STA.
